(19) United States
(12) Patent Application Publication
(10) Pub. No.: US 2017/0289009 A1
(43) Pub. Date: Oct. 5, 2017

(54) METHOD AND DEVICE FOR DOWNLOADING A VIDEO FILE AND PROVIDING A VIDEO FILE

(71) Applicants: Le Holdings(Beijing)Co., Ltd., Beijing (CN); LE SHI ZHI XIN ELECTRONIC TECHNOLOGY (TIAN JIN) LIMITED, Tianjin (CN)

(72) Inventor: Zhigang Wu, Tianjin (CN)

(21) Appl. No.: 15/247,604

(22) Filed: Aug. 25, 2016

Related U.S. Application Data
(63) Continuation of application No. PCT/CN2016/088983, filed on Jul. 6, 2016.

(30) Foreign Application Priority Data
Mar. 31, 2016 (CN) 201610201754.2

(51) Int. Cl. H04L 12/26; H04L 29/08; H04L 29/06

(52) U.S. Cl. CPC H04L 43/16; H04L 65/60; H04L 67/06

(57) ABSTRACT

The disclosure provides a method and device for downloading a video file. A client detects a current network speed, transmits a notification carrying information about the current network speed to a media server, and downloads video segments provided by the media server, wherein a video file includes several video segments.

### CROSS REFERENCE TO RELATED APPLICATIONS

This application is a continuation of International Application No. PCT/CN2016/088983, filed on Jul. 6, 2016, which is based upon and claims priority to Chinese Patent Application No. 201610201754.2, filed on Mar. 31, 2016, the entire contents of which are incorporated herein by reference.

### TECHNICAL FIELD

The disclosure relates to the field of video technologies, and particularly to a method and device for downloading a video file and providing a video file.

### BACKGROUD

Playing of a network video (including a video on demand and a live video) is an important and core function of mobile terminals and TV sets. There are such a variety of speeds of networks that some networks have a high access speed, whereas some networks have a low access speed; and the speeds of the networks may not be stable because if there are a large number of bandwidth sharing users accessing the network, then the speed of the network may significantly drop. In order to provide the users with an optimum better experience, a video website generally prepares video sources with a variety of definitions for the same video, and provides a list for the users to select from, where the list includes the video sources in an order of ascending definitions including Extreme, Smooth, Standard Definition, High Definition, Ultra-High Definition, 1080P, 4K, etc.

The inventors have identified during making of the invention that a high-definition video file is selected and played by default in the prior art although the default definition may not be appropriate for the real network speed. If there is a low network speed, then the prompt of “Struggling to download . . . ” may be presented frequently while the video is being played, thus greatly degrading the experience of the users watching the video; and if there is such a high network speed that a video file at a higher definition can be played, then the watchers may have no chance to enjoy the optimum experience of watching the video. Since the network speed is so instable that it may become high or low from time to time, if the video is fixed at the same definition, then the video may be interrupted occasionally, and although the user being presented with the prompt of “Struggling to download . . . ” may select manually the video file at a lower definition for watching, thereafter the video file at the lower definition may be played all the time instead of being switched automatically to the optimum definition even after the network speed is recovered, thus degrading the experience of the user watching the network video.

In summary, a drawback in the prior art lies in that the video cannot be switched to a video file at a definition matching the current network speed.

### SUMMARY

Embodiments of the disclosure provide a method and device for downloading a video file and providing a video file so as to address such a problem in the prior art that the video cannot be switched to a video file at a definition matching the current network speed.

In an aspect, embodiments of the disclosure provides a method for downloading a video file, the method including: at an electronic device:

detecting a current network speed;

transmitting a notification carrying information about the current network speed to a media server; and

downloading video segments provided by the media server, wherein a video file includes several video segments.

In another aspect, embodiments of the disclosure provides an electronic device, including:

at least one processor; and

a memory communicably connected with the at least one processor for storing instructions executable by the at least one processor, wherein execution of the instructions by the at least one processor causes the at least one processor to:

detect a current network speed;

transmit a notification carrying information about the current network speed to a media server; and

download video segments provided by the media server, wherein a video file includes several video segments.

In a further aspect, embodiments of the disclosure provides a non-transitory computer-readable storage medium storing executable instructions that, when executed by an electronic device with a touch-sensitive display, cause the electronic device to:

detect a current network speed;

transmit a notification carrying information about the current network speed to a media server; and

download video segments provided by the media server, wherein a video file includes several video segments.

In the solutions for downloading a video file and providing a video file according to the embodiments of the disclosure, the client detects the current network speed, and transmits the notification carrying the information about the current network speed to the media server; the media server receives the notification, determines the video segments at the corresponding level of definition for the client to download, according to the mapping relationship between the current network speed determined from the information about the current network speed, and the level of definition of the video segments, and provides the client with the video segments at the corresponding level of definition; and the client downloads the video segments provided by the media server. The media server can determine the current network speed of the client from the notification provided by the client, and thereby provide the video segments at the corresponding level of definition for the client to download, where there are the same data of the video segments at the different definitions, so that the definition of a video file can be switched automatically in response to the network speed without hindering the video from being watched on the client, thus ensuring the video to be played smoothly.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for downloading a video file in accordance with some embodiments.

FIG. 2 is a flow chart of a method for providing a video file in accordance with some embodiments;

FIG. 3 is a flow chart of playing a network video at an adaptive definition in accordance with some embodiments;

FIG. 4 is a schematic structural diagram of an apparatus for downloading a video file in accordance with some embodiments;

FIG. 5 is a schematic structural diagram of an apparatus for providing a video file in accordance with some embodiments;

FIG. 6 is a schematic structural diagram of another apparatus for downloading a video file in accordance with some embodiments;

FIG. 7 is a schematic diagram of a first computer readable storage medium in accordance with some embodiments;

FIG. 8 is a schematic structural diagram of another apparatus for providing a video file in accordance with some embodiments;

FIG. 9 is a schematic diagram of a second computer readable storage medium in accordance with some embodiments; and

FIG. 10 is a schematic diagram of an electronic device for downloading a video file in accordance with some embodiments.

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

Firstly a method for downloading a video file on a client will be described below in details.

FIG. 1 is a flow chart of an embodiment of the method for downloading a video file, and as illustrated, the method can include the following operations:

The operation 101 is to detect a current network speed;

The operation 102 is transmit a notification carrying information about the current network speed to a media server; and

The operation 103 is to download video segments provided by the media server, where a video file includes several video segments.

The operation 101 is performed where the network speed may become instable due to a variety of reasons, for example, if there are a larger number of network bandwidth sharing users accessing the network, then the network speed may drop; and if there are a smaller number of users accessing the network, then the network speed may raise, so the current network speed can be detected in real time to thereby obtain the real-time network speed.

In an implementation, the current network speed is determined according to a speed at which video segments are buffered in a buffer area.

Particularly if the network speed drops, then the speed at which video segments are buffered in the buffer area may drop; and if the network speed raises, then the speed at which video segments are buffered in the buffer area may raise, so the current network speed can be determined by detecting the speed at which video segments are buffered in the buffer area.

The operation 102 is performed where the information about the detected current network speed is notified to the media server so that the media server provides the video segments at different definitions for the client to download.

In an implementation, the notification can be transmitted to the media server when the current network speed is below a preset threshold or above the preset threshold.

Particularly if the current network speed is below the preset threshold or above the preset threshold, then this may indicate that the current network speed is instable and has become such that the video segments need to be replaced with those at a different definition, so the information about the detected current network speed needs to be notified to the media server so that the media server provides the video segments at a different definition for the client to download.

The operation 103 is performed where the media server segments a video file into several media segments in the field of streaming media. The media server can provide the client with the video segments at the corresponding definition in response to the received notification. The client can download the video segments provided by the media server.

Further to the description of the embodiment of the method at the client side, a method for providing a video file on a media server will be described below in details.

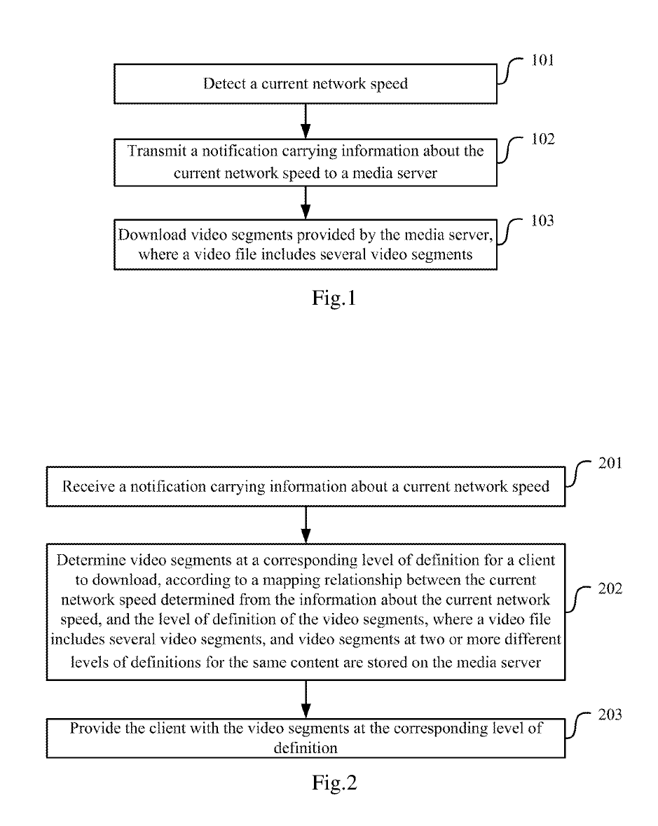

FIG. 2 is a flow chart of an embodiment of a method for providing a video file, and as illustrated, the method can include the following operations:

The operation 201 is to receive a notification carrying information about a current network speed;

The operation 202 is to determine video segments at a corresponding level of definition for a client to download, according to a mapping relationship between the current network speed determined from the information about the current network speed, and the level of definition of the video segments, where a video file includes several video segments, and video segments at two or more different levels of definitions for the same content are stored on the media server; and

The operation 203 is to provide the client with the video segments at the corresponding level of definition.

The operation 201 is performed where the media server receives the notification carrying the information about the current network speed transmitted by the client so that the media server can know the network speed on the client, and thereby determine the definition of the video segments.

The operation 202 is performed where the media server determines the current network speed from the information about the current network speed carried in the notification, and since the mapping relationship between the current network speed and the level of definition of the video segments is preset, the media server can determine the video segments at the corresponding level of definition according to the current network speed and the mapping relationship, and provide the video segments for the client to download. In the field of streaming media, the media server segments a video file into several video segments, and video segments at two or more different levels of definitions are stored for the same content, so the video can remain consecutive while definitions of the video segments are being switching, to thereby ensure the video to be played consecutively on the client.

In an implementation, the mapping relationship between the current network speed and the level of definition of the video segments is such that:

There is a positive correlation between the current network speed and the level of definition of the video segments.

Particularly if there is a positive correlation between the current network speed and the level of definition of the video segments, then there will be video segments at a high level of definition corresponding to the current network speed which is high; and video segments at a low level of definition corresponding to the current network speed which is low. If there are video sources at three levels of definitions, including Standard Definition, High Definition, and Ultra-High Definition, stored on the media server, and the network speed is categorized in the equation of:

$$v = \{ \begin{matrix}{v}_{1} , {v}_{1} < {x}_{1} \\ {v}_{2} , {x}_{1} < {v}_{2} < {x}_{2} \\ {v}_{3} , {v}_{3} > {x}_{2}\end{matrix} \qquad [ 1 ]$$

Where x1 represents a first threshold, x2 represents a second threshold, and v, v1, v2, and v3 represent network speeds,

Then v=v1 will correspond to video segments at the level of definition which is Standard Definition, v=v2 will correspond to video segments at the level of definition which is High Definition, and v=v3 will correspond to video segments at the level of definition which is Ultra-High Definition. In a particular implementation, the network speed can be replaced with a speed at which video segments are buffered in a buffer area.

The operation 203 is performed where the client is provided with the video segments at the corresponding level of definition so that the client can download and watch the video segments at the corresponding level of definition without switching manually the definition of the video.

In order to make the disclosure more apparent, a particular embodiment thereof will be described below.

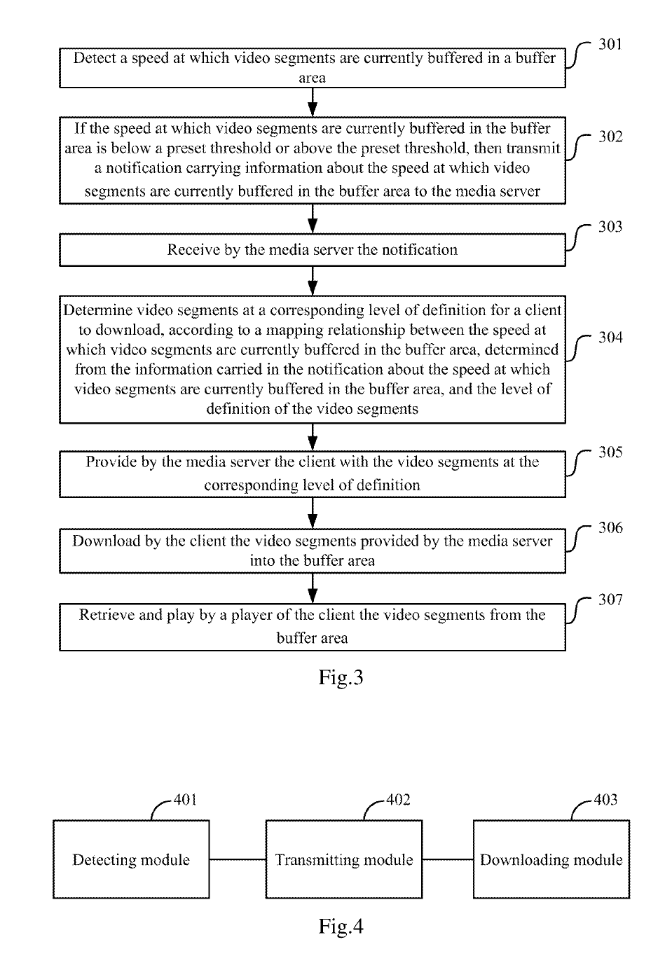

FIG. 3 is a flow chart of an embodiment of playing a network video at an adaptive definition, and as illustrated, the flow can include the following operations:

The operation 301 is to detect a speed at which video segments are currently buffered in a buffer area;

The operation 302 is, if the speed at which video segments are currently buffered in the buffer area is below a preset threshold or above the preset threshold, to transmit a notification carrying information about the speed at which video segments are currently buffered in the buffer area to the media server;

The operation 303 is to receive by the media server the notification;

The operation 304 is to determine video segments at a corresponding level of definition for a client to download, according to a mapping relationship between the speed at which video segments are currently buffered in the buffer area, determined from the information carried in the notification about the speed at which video segments are currently buffered in the buffer area, and the level of definition of the video segments;

The operation 305 is to provide by the media server the client with the video segments at the corresponding level of definition;

The operation 306 is to download by the client the video segments provided by the media server into the buffer area; and

The operation 307 is to retrieve and play by a player of the client the video segments from the buffer area.

The operation 304 is performed where in the field of streaming media, the media server segments a video file into several video segments, and video segments at two or more different levels of definitions are stored for the same content, so the video can remain consecutive while definitions of the video segments are being switching, to thereby ensure the video to be played consecutively on the client.

The operation 306 is performed where the downloaded video segments are stored in the high-speed buffer area, and typically the capacity of the high-speed buffer is not high because data are stored in the high-speed buffer using a loop linked table structure so that played data are discarded to reuse a space vacated in the high-speed buffer to buffer subsequent data to be played.

As can be apparent, in this embodiment, the media server can determine the current network speed of the client from the notification provided by the client, and thereby provide the video segments at the corresponding level of definition for the client to download, where there are the same data of the video segments at the different definitions, so that the definition of a video file can be switched automatically in response to the network speed without hindering the video from being watched on the client, thus ensuring the video to be played smoothly.

It shall be noted that in order to enable the video to be played at an adaptive definition, the organization and transmission of a play list on the media server will also be modified accordingly. For a player supporting adaptive playing, a play list of video segments at respective definitions is provided, and for an existing player which does not support adaptive playing, a play list of video segments at a single definition is provided for compatibility.

Based upon the same inventive idea, embodiments of the disclosure further provide an apparatus for downloading a video file, and an apparatus for providing a video file, and since these devices address the problem under a similar principle to the method for downloading a video file, and the method for providing a video file, reference can be made to the implementations of the methods for implementations of these apparatuses, so a repeated description thereof will be omitted here.

FIG. 4 is a schematic structural diagram of an embodiment of an apparatus for downloading a video file, and as illustrated, the apparatus can include:

A detecting module 401 is configured to detect a current network speed;

A transmitting module 402 is configured to transmit a notification carrying information about the current network speed to a media server; and

A downloading module 403 is configured to download video segments provided by the media server, where a video file includes several video segments.

In an implementation, the detecting module can be further configured to detect the current network speed according to a speed at which video segments are buffered in a buffer area.

In an implementation, the transmitting module can be further configured to transmit the notification to the media server when the current network speed is below a preset threshold or above the preset threshold.

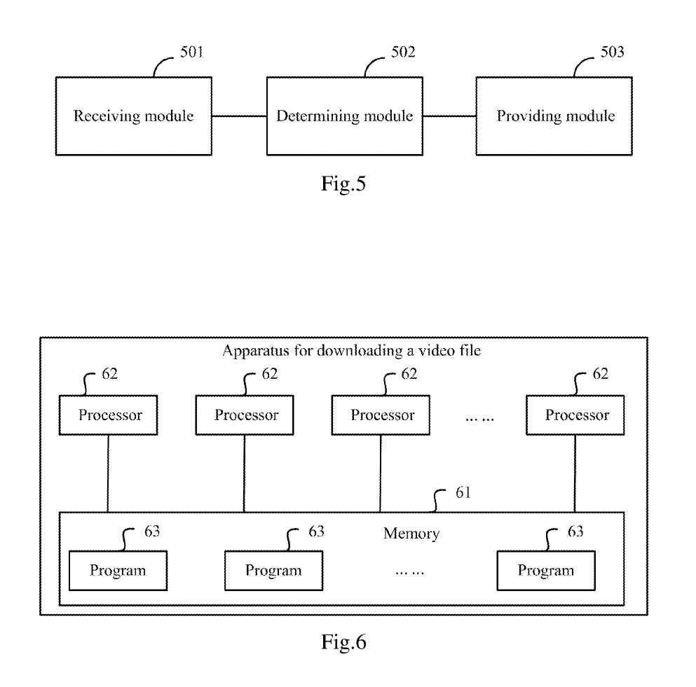

FIG. 5 is a schematic structural diagram of an embodiment of an apparatus for providing a video file, and as illustrated, the apparatus can include:

A receiving module 501 is configured to receive a notification carrying information about a current network speed;

A determining module 502 is configured to determine video segments at a corresponding level of definition for a client to download, according to a mapping relationship between the current network speed determined from the information about the current network speed, and the level of definition of the video segments, where a video file includes several video segments, and video segments at two or more different levels of definitions for the same content are stored on a media server; and

A providing module 503 is configured to provide the client with the video segments at the corresponding level of definition.

In an implementation, the determining module can be further configured to determine the video segments at the corresponding level of definition for the client to download, according to a positive correlation between the current network speed determined from the information about the current network speed, and the level of definition of the video segments.

As illustrated in FIG. 6, there is a schematic structural diagram of another apparatus for downloading a video file according to an embodiment of the disclosure, where the apparatus includes a memory 61, one or more processors 62, and one or more programs 63, where the one or more programs 63 are configured, upon being executed by the one or more processors 62, to perform the operations of: detecting a current network speed; transmitting a notification carrying information about the current network speed to a media server; and downloading video segments provided by the media server, where a video file includes several video segments.

An embodiment of the disclosure further provides a computer readable storage medium on which there are stored computer executable instructions configured to be executed by an apparatus for downloading a video file to perform the operations of: detecting a current network speed; transmitting a notification carrying information about the current network speed to a media server; and downloading video segments provided by the media server, where a video file includes several video segments.

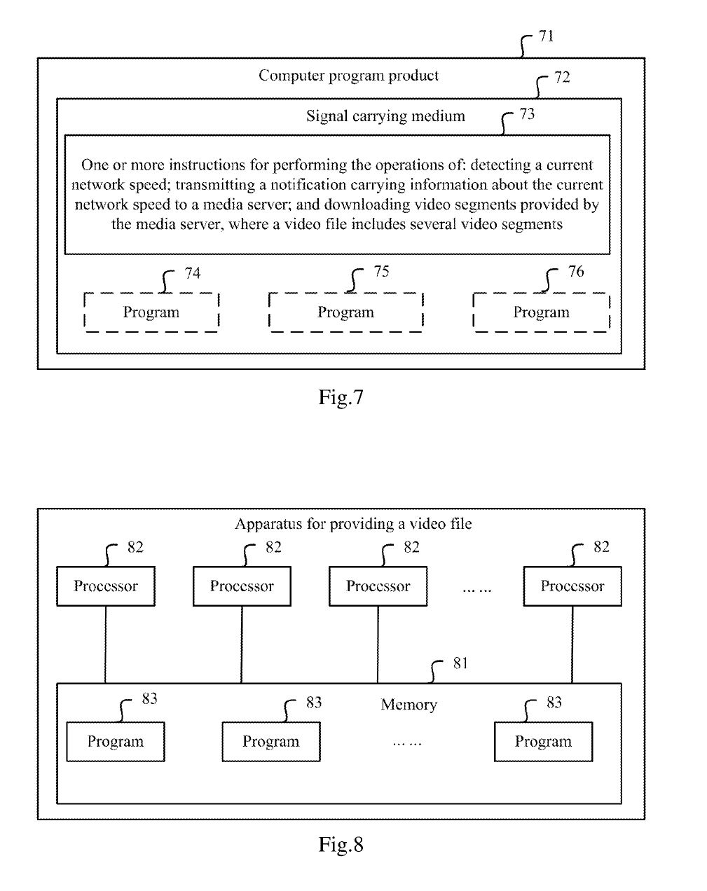

As illustrated in FIG. 7, a computer readable storage medium 71 stores thereon a computer program product 72 which can include any combination of one or more readable medium, e.g., a signal carrying medium 73, a computer readable medium 74, a recordable medium 75, a communication medium 76, etc., where the signal carrying medium 73 stores therein one or more instructions for performing the operations of: detecting a current network speed; transmitting a notification carrying information about the current network speed to a media server; and downloading video segments provided by the media server, where a video file includes several video segments.

As illustrated in FIG. 8, there is a schematic structural diagram of another apparatus for providing a video file according to an embodiment of the disclosure, where the apparatus includes a memory 81, one or more processors 82, and one or more programs 83, where the one or more programs 83 are configured, upon being executed by the one or more processors 82, to perform the operations of: receiving a notification carrying information about a current network speed; determining video segments at a corresponding level of definition for a client to download, according to a mapping relationship between the current network speed determined from the information about the current network speed, and the level of definition of the video segments, where a video file includes several video segments, and video segments at two or more different levels of definitions for the same content are stored on a media server; and providing the client with the video segments at the corresponding level of definition.

An embodiment of the disclosure further provides a computer readable storage medium on which there are stored computer executable instructions configured to be executed by an apparatus for providing a video file to perform the operations of: receiving a notification carrying information about a current network speed; determining video segments at a corresponding level of definition for a client to download, according to a mapping relationship between the current network speed determined from the information about the current network speed, and the level of definition of the video segments, where a video file includes several video segments, and video segments at two or more different levels of definitions for the same content are stored on a media server; and providing the client with the video segments at the corresponding level of definition.

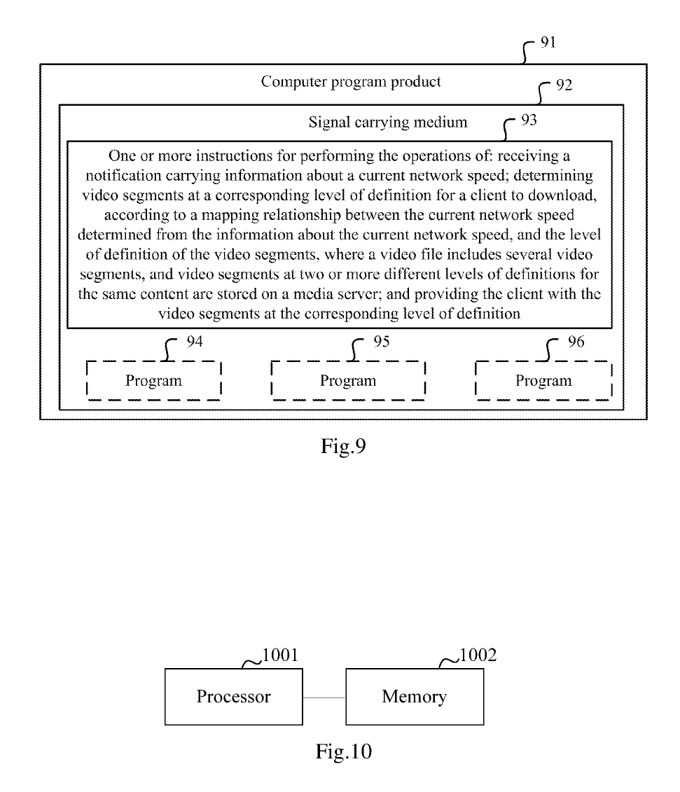

As illustrated in FIG. 9, a computer readable storage medium 91 stores thereon a computer program product 92 which can include any combination of one or more readable medium, e.g., a signal carrying medium 93, a computer readable medium 94, a recordable medium 95, a communication medium 96, etc., where the signal carrying medium 93 stores therein one or more instructions for performing the operations of: receiving a notification carrying information about a current network speed; determining video segments at a corresponding level of definition for a client to download, according to a mapping relationship between the current network speed determined from the information about the current network speed, and the level of definition of the video segments, where a video file includes several video segments, and video segments at two or more different levels of definitions for the same content are stored on a media server; and providing the client with the video segments at the corresponding level of definition.

Based upon the same inventive idea, an embodiment of the disclosure further provides an electronic device for downloading a video file, as illustrated in FIG. 10, which includes:

At least one processor 1001 and a memory 1002, where there is one processor as an example in FIG. 10.

The memory 1002 is communicably connected with the at least one processor for storing instructions executable by the at least one processor, wherein execution of the instructions by the at least one processor causes the at least one processor to:

Detect a current network speed;

Transmit a notification carrying information about the current network speed to a media server; and

Download video segments provided by the media server, wherein a video file comprises several video segments.

In one embodiment, the execution of the instructions by the at least one processor further causes the at least one processor to:

Determine the current network speed according to a speed at which video segments are buffered in a buffer area.

In one embodiment, the execution of the instructions by the at least one processor further causes the at least one processor to:

Transmit the notification to the media server when the current network speed is below a preset threshold or above the preset threshold.

Based upon the same inventive idea, an embodiment of the disclosure further provides a non-transitory computer-readable storage medium storing executable instructions that, when executed by an electronic device with a touch-sensitive display, cause the electronic device to:

Detect a current network speed;

Transmit a notification carrying information about the current network speed to a media server; and

Download video segments provided by the media server, wherein a video file comprises several video segments.

In one embodiment, the executable instructions executed by the electronic device further cause the electronic device to:

Determine the current network speed according to a speed at which video segments are buffered in a buffer area.

In one embodiment, the executable instructions executed by the electronic device further cause the electronic device to:

Transmit the notification to the media server when the current network speed is below a preset threshold or above the preset threshold.

The aforementioned electronic device can execute the method according to some embodiments of the disclosure, and has functional modules for executing corresponding method and advantageous thereof. For more technical details, the method according to some embodiments of the disclosure can be referred.

The electronic device according to some embodiments of the disclosure can be in multiple forms, which include but not limit to:

1. Mobile communication device, of which characteristic has mobile communication function, and briefly acts to provide voice and data communication. These terminals include smart pone (i.e. iPhone), multimedia mobile phone, feature phone, cheap phone and etc.

2. Ultra mobile personal computing device, which belongs to personal computer, and has function of calculation and process, and has mobile networking function in general. These terminals include PDA, MID, UMPC (Ultra Mobile Personal Computer) and etc.

3. Portable entertainment equipment, which can display and play multimedia contents. These equipments include audio player, video player (e.g. iPod), handheld game player, electronic book, hobby robot and portable vehicle navigation device.

4. Server, which provides computing services, and includes processor, hard disk, memory, system bus and etc. The framework of the server is similar to the framework of universal computer, however, there is a higher requirement for processing capacity, stability, reliability, safety, expandability, manageability and etc due to supply of high reliability services.

5. Other electronic devices having data interaction function.

The embodiments of the apparatus described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure. This can be understood and practiced by those ordinarily skilled in the art without any inventive effort.

Those ordinarily skilled in the art can appreciate that all or a part of the operations in the methods according to the embodiments described above can be performed by program instructing relevant hardware, where the programs can be stored in a computer readable storage medium, and the programs can perform one or a combination of the operations in the embodiments of the method upon being executed; and the storage medium includes an ROM, an RAM, a magnetic disc, an optical disk, or any other medium which can store program codes.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A method for downloading a video file, the method comprising:
at an electronic device:
detecting a current network speed;
transmitting a notification carrying information about the current network speed to a media server; and
downloading video segments provided by the media server, wherein a video file comprises several video segments.

2. The method according to claim 1, wherein the current network speed is determined according to a speed at which video segments are buffered in a buffer area.

3. The method according to claim 1, wherein the notification is transmitted to the media server when the current network speed is below a preset threshold or above the preset threshold.

4. The method according to claim 2, wherein the notification is transmitted to the media server when the current network speed is below a preset threshold or above the preset threshold.

5. An electronic device, comprising:
at least one processor; and
a memory communicably connected with the at least one processor for storing instructions executable by the at least one processor, wherein execution of the instructions by the at least one processor causes the at least one processor to:
detect a current network speed;
transmit a notification carrying information about the current network speed to a media server; and
download video segments provided by the media server, wherein a video file comprises several video segments.

6. The electronic device according to claim 5, wherein the execution of the instructions by the at least one processor further causes the at least one processor to:
determine the current network speed according to a speed at which video segments are buffered in a buffer area.

7. The electronic device according to claim 5, wherein the execution of the instructions by the at least one processor further causes the at least one processor to:
transmit the notification to the media server when the current network speed is below a preset threshold or above the preset threshold.

8. The electronic device according to claim 6, wherein the execution of the instructions by the at least one processor further causes the at least one processor to:
transmit the notification to the media server when the current network speed is below a preset threshold or above the preset threshold.

9. A non-transitory computer-readable storage medium storing executable instructions that, when executed by an electronic device with a touch-sensitive display, cause the electronic device to:
detect a current network speed;
transmit a notification carrying information about the current network speed to a media server; and
download video segments provided by the media server, wherein a video file comprises several video segments.

10. The non-transitory computer-readable storage medium according to claim 9, wherein the executable instructions executed by the electronic device further cause the electronic device to:
determine the current network speed according to a speed at which video segments are buffered in a buffer area.

11. The non-transitory computer-readable storage medium according to claim 9, wherein the executable instructions executed by the electronic device further cause the electronic device to:
transmit the notification to the media server when the current network speed is below a preset threshold or above the preset threshold.

12. The non-transitory computer-readable storage medium according to claim 10, wherein the executable instructions executed by the electronic device further cause the electronic device to:
transmit the notification to the media server when the current network speed is below a preset threshold or above the preset threshold.
